(19) United States
(12) Patent Application Publication
(10) Pub. No.: US 2021/0158533 A1
(43) Pub. Date: May 27, 2021

(54) IMAGE PROCESSING METHOD AND APPARATUS, AND STORAGE MEDIUM

(71) Applicant: BEIJING SENSETIME TECHNOLOGY DEVELOPMENT CO., LTD., Beijing (CN)

(72) Inventors: Hejie CUI, Beijing (CN); Xinglong LIU, Beijing (CN); Ning HUANG, Beijing (CN)

(73) Assignee: BEIJING SENSETIME TECHNOLOGY DEVELOPMENT CO., LTD., Beijing (CN)

(21) Appl. No.: 17/138,746

(22) Filed: Dec. 30, 2020

Related U.S. Application Data
(63) Continuation of application No. PCT/CN2019/106642, filed on Sep. 19, 2019.

(30) Foreign Application Priority Data
Apr. 18, 2019 (CN) 201910315190.9

(51) Int. Cl. G06T 7/187; G06K 9/46; G06K 9/62; G06T 3/40; G06T 1/20; G06T 7/11

(52) U.S. Cl. CPC G06T 7/187; G06K 9/46; G06K 9/6256; G06T 3/4046; G06T 2207/20084; G06T 7/11; G06T 2207/20021; G06T 2207/20081; G06T 1/20

(57) ABSTRACT

The present disclosure relates to an image processing method and apparatus, and a storage medium. The method includes: performing feature extraction on a to-be-processed image to obtain an intermediate processing image; performing segmentation processing on the intermediate processing image to obtain a first segmentation result; and performing structure reconstruction on the first segmentation result according to structure information of the first segmentation result, to obtain a final segmentation result of a target object in the to-be-processed image. According to the embodiments of the present disclosure, further correction of the segmentation result of the to-be-processed image can be implemented according to the structure information of the target object in the to-be-processed image, thereby improving the integrity and the accuracy of the segmentation result, and then improving the precision of image processing.

### CROSS REFERENCE TO RELATED APPLICATIONS

The present application is a continuation of and claims priority under 35 U.S.C. § 120 to PCT Application. No. PCT/CN2019/106642, filed on Sep. 19, 2019, which claims priority to Chinese Patent Application No. 201910315190.9, filed with the Chinese Patent Office on Apr. 18, 2019 and entitled “IMAGE PROCESSING METHOD AND APPARATUS, ELECTRONIC DEVICE, AND STORAGE MEDIUM”. All the above-referenced priority documents are incorporated herein by reference in their entirety.

### TECHNICAL FIELD

The present disclosure relates to the technical field of image processing, and in particular, to an image processing method and apparatus, an electronic device, and a storage medium.

### BACKGROUND

The lung of a human body is an exchange site of metabolism-produced gases, and includes abundant tracheal and vascular tissues, so the structure is relatively complex; moreover, the arteries and veins of the lung are intertwined with and accompanied by each other, so the difficulty of segmentation is further increased. Therefore, how to achieve relatively precise segmentation of blood vessels in a lung image has become an urgent problem needing to be solved at present.

### SUMMARY

The present disclosure provides technical solutions of image processing.

According to one aspect of the present disclosure, provided is an image processing method, including: performing feature extraction on a to-be-processed image to obtain an intermediate processing image; performing segmentation processing on the intermediate processing image to obtain a first segmentation result; and performing structure reconstruction on the first segmentation result according to structure information of the first segmentation result, to obtain a final segmentation result of a target object in the to-be-processed image.

In the embodiments of the present disclosure, an initial segmentation result is obtained by performing segmentation processing after performing feature extraction on the to-be-processed image, and then the final segmentation result of the target object in the to-be-processed image is obtained by performing structure reconstruction based on the initial segmentation result by using the structure information therein. By means of the above process, further correction is performed on the segmentation result of the to-be-processed image according to the structure information of the target object in the to-be-processed image, thereby improving the integrity and the accuracy of the segmentation result, and then improving the precision of image processing.

In one possible implementation, performing feature extraction on the to-be-processed image to obtain the intermediate processing image includes: cutting the to-be-processed image according to a predetermined direction to obtain multiple to-be-processed sub-images; performing feature extraction on each of the to-be-processed sub-images to obtain an intermediate processing sub-image respectively corresponding to each to-be-processed sub-image; and splicing all the intermediate processing sub-images according to the predetermined direction to obtain the intermediate processing image.

In the embodiments of the present disclosure, by cutting the to-be-processed image to obtain multiple to-be-processed sub-images, performing extraction on each of the to-be-processed sub-images respectively, and then splicing the multiple intermediate processing sub-images obtained through feature extraction according to the predetermined direction, a corresponding intermediate processing image is obtained. By means of such a process, the to-be-processed image may be cut into multiple to-be-processed sub-images of appropriate size when the to-be-processed image is too large, thereby effectively reducing the size of an input image for feature extraction and reducing the probability that the accuracy of the feature extraction result is reduced due to the too large input image. Therefore, the precision of feature extraction is improved, so that the obtained intermediate processing image has higher accuracy, and then the precision of the entire image processing process is improved. In addition, the probability of memory overflow caused by the too large to-be-processed image is also reduced, and thus memory consumption is effectively reduced.

In one possible implementation, cutting the to-be-processed image according to the predetermined direction to obtain the multiple to-be-processed sub-images includes: determining multiple cutting centers on the to-be-processed image; and cutting the to-be-processed image according to the predetermined direction in accordance with positions of the cutting centers to obtain the multiple to-be-processed sub-images, where each cutting center is located at the center of a corresponding to-be-processed sub-image respectively, and an overlapping region exists between adjacent to-be-processed sub-images.

In the embodiments of the present disclosure, by means of cutting, the overlapping region exists between adjacent to-be-processed sub-images, so that the probability that part of image information related to the target object is lost due to the cutting of the to-be-processed image is reduced, thereby improving the degrees of completeness and accuracy of the obtained feature extraction result, and then improving the precision and degree of completeness of the final segmentation result, that is, improving the precision of image processing.

In one possible implementation, before cutting the to-be-processed image according to the predetermined direction to obtain the multiple to-be-processed sub-images, the method further includes: performing scaling processing on the to-be-processed image in directions other than the predetermined direction according to predetermined parameters.

In the embodiments of the present disclosure, by performing scaling processing on the to-be-processed image in directions other than the predetermined direction, the size of the to-be-processed image may be unified, thereby facilitating the subsequent image processing, and improving the efficiency of image processing.

In one possible implementation, before performing feature extraction on the to-be-processed image to obtain the intermediate processing image, the method further includes: obtaining a training sample data set; and training, according to the training sample data set, a neural network used for feature extraction.

In the embodiments of the present disclosure, by training the neural network used for feature extraction, feature extraction of the to-be-processed image may be implemented through the neural network, thereby improving the precision of the obtained intermediate processing image, and thus the precision of image processing is improved.

In one possible implementation, obtaining the training sample data set includes: correcting original data to obtain corrected annotation data; and obtaining the training sample data set according to the corrected annotation data.

In the embodiments of the present disclosure, by correcting the original data to obtain annotation data, the quality of the training data is improved, thereby improving the precision of the neural network obtained by training, and thus the precision of feature extraction may be improved to further improve the precision of image processing.

In one possible implementation, training, according to the training sample data set, the neural network used for feature extraction includes: obtaining a global loss and a false positive penalty loss of the neural network according to the training sample data set in combination with a preset weight coefficient respectively; determining a loss function of the neural network according to the global loss and the false positive penalty loss; and training the neural network according to back propagation of the loss function.

In the embodiments of the present disclosure, by means of the loss function in the above form, the problem that the trained neural network has a high false positive rate and a low recall rate due to the small proportion of the target object in the overall picture can be effectively alleviated. Therefore, the degree of accuracy of the trained neural network can be improved, thereby improving the precision of the intermediate processing image obtained by performing feature extraction on the to-be-processed image, and then improving the precision of the final segmentation result and the accuracy of image processing.

In one possible implementation, performing segmentation processing on the intermediate processing image to obtain the first segmentation result includes: performing segmentation processing on the intermediate processing image by means of Grow Cut, to obtain the first segmentation result, where the Grow Cut is implemented in a graphic processing unit through a deep learning framework.

In the embodiments of the present disclosure, when performing segmentation processing on the intermediate processing image by means of Grow Cut, implementing the Grow Cut in the GPU through the deep learning framework may greatly improve the speed of segmentation processing, and thereby effectively improving the speed of the entire image processing method.

In one possible implementation, performing structure reconstruction on the first segmentation result according to the structure information of the first segmentation result, to obtain the final segmentation result of the target object in the to-be-processed image includes: performing center extraction on the first segmentation result to obtain a central region image and a distance field value set, where the distance field value set is a set of distance field values between all voxel points on the central region image and a boundary of the target object in the first segmentation result; generating a first topological structure diagram of the target object according to the central region image; performing connection processing on the first topological structure diagram to obtain a second topological structure diagram; and performing structure reconstruction on the second topological structure diagram according to the distance field value set, to obtain the final segmentation result of the target object in the to-be-processed image.

In the embodiments of the present disclosure, by performing structured reconstruction based on the first segmentation result, i.e., performing structured reconstruction based on real data, the final segmentation result may have higher authenticity.

In one possible implementation, performing connection processing on the first topological structure diagram to obtain the second topological structure diagram includes: extracting a connected region corresponding to the target object from the first topological structure diagram; and removing voxel points from the first topological structure diagram whose connectivity values with the connected region are lower than a connectivity threshold, to obtain a second topological structure diagram.

In the embodiments of the present disclosure, the process of performing connection processing on the first topological structure diagram to obtain the second topological structure diagram may effectively improve the connectivity of the first segmentation result. Removing noise points in the first segmentation result and performing effective correction on the first segmentation result improve the accuracy of the obtained final segmentation result.

In one possible implementation, performing structure reconstruction on the second topological structure diagram according to the distance field value set, to obtain the final segmentation result of the target object in the to-be-processed image includes: performing drawing by taking each point in the second topological structure diagram as a sphere center and each distance field value in the distance field value set as a radius, and adding the overlapping region included in the drawing to the second topological structure diagram, to obtain the final segmentation result of the target object in the to-be-processed image.

In the embodiments of the present disclosure, the final segmentation result obtained by performing structured reconstruction on the target object by using the second topological structure diagram and the distance field value set may effectively reflect the information of each node and branch of the target object, and has relatively high precision.

In one possible implementation, before performing feature extraction on the to-be-processed image to obtain the intermediate processing image, the method further includes: performing preprocessing on the to-be-processed image, where the preprocessing includes one or more of resampling, value definition, and normalization.

In the embodiments of the present disclosure, by performing preprocessing on the to-be-processed image, the processing efficiency of subsequently performing feature extraction, segmentation processing, and structure reconstruction on the to-be-processed image in sequence is improved, and the time of the entire image processing process is shortened; moreover, the degree of accuracy of image segmentation is also improved, thereby improving the precision of the image processing result.

According to one aspect of the present disclosure, provided is an image processing apparatus, including: a feature extraction module, configured to perform feature extraction on a to-be-processed image to obtain an intermediate processing image; a segmentation module, configured to perform segmentation processing on the intermediate processing image to obtain a first segmentation result; and a structure reconstruction module, configured to perform structure reconstruction on the first segmentation result according to structure information of the first segmentation result, to obtain a final segmentation result of a target object in the to-be-processed image.

In one possible implementation, the feature extraction module includes: a cutting sub-module, configured to cut the to-be-processed image according to a predetermined direction to obtain multiple to-be-processed sub-images; a feature extraction sub-module, configured to perform feature extraction on each of the to-be-processed sub-images to obtain an intermediate processing sub-image respectively corresponding to each to-be-processed sub-image; and a splicing sub-module, configured to splice all the intermediate processing sub-images according to the predetermined direction to obtain the intermediate processing image.

In one possible implementation, the cutting sub-module is configured to: determine multiple cutting centers on the to-be-processed image; and cut the to-be-processed image according to the predetermined direction in accordance with positions of the cutting centers to obtain the multiple to-be-processed sub-images, where each cutting center is located at the center of a corresponding to-be-processed sub-image respectively, and an overlapping region exists between adjacent to-be-processed sub-images.

In one possible implementation, the apparatus further includes a scaling sub-module before the cutting sub-module, where the scaling sub-module is configured to: perform scaling processing on the to-be-processed image in directions other than the predetermined direction according to predetermined parameters.

In one possible implementation, the apparatus further includes a training module before the feature extraction module, where the training module includes: a sample obtaining sub-module, configured to obtain a training sample data set; and a training sub-module, configured to train, according to the training sample data set, a neural network used for feature extraction.

In one possible implementation, the sample obtaining sub-module is configured to: correct original data to obtain corrected annotation data; and obtain the training sample data set according to the corrected annotation data.

In one possible implementation, the training sub-module is configured to: obtain a global loss and a false positive penalty loss of the neural network according to the training sample data set in combination with a preset weight coefficient respectively; determine a loss function of the neural network according to the global loss and the false positive penalty loss; and train the neural network according to back propagation of the loss function.

In one possible implementation, the segmentation module is configured to: perform segmentation processing on the intermediate processing image by means of Grow Cut, to obtain the first segmentation result, where the Grow Cut is implemented in a graphic processing unit through a deep learning framework.

In one possible implementation, the structure reconstruction module includes: a center extraction sub-module, configured to perform center extraction on the first segmentation result to obtain a central region image and a distance field value set, where the distance field value set is a set of distance field values between all voxel points on the central region image and a boundary of the target object in the first segmentation result; a topological structure generation sub-module, configured to generate a first topological structure diagram of the target object according to the central region image; a connection processing sub-module, configured to perform connection processing on the first topological structure diagram to obtain a second topological structure diagram; and a structure reconstruction sub-module, configured to perform structure reconstruction on the second topological structure diagram according to the distance field value set, to obtain the final segmentation result of the target object in the to-be-processed image.

In one possible implementation, the connection processing sub-module is configured to: extract a connected region corresponding to the target object from the first topological structure diagram; and remove voxel points from the first topological structure diagram whose connectivity values with the connected region are lower than a connectivity threshold, to obtain a second topological structure diagram.

In one possible implementation, the structure reconstruction sub-module is configured to: perform drawing by taking each point in the second topological structure diagram as a sphere center and each distance field value in the distance field value set as a radius, and add the overlapping region included in the drawing to the second topological structure diagram, to obtain the final segmentation result of the target object in the to-be-processed image.

In one possible implementation, the apparatus further includes a preprocessing module before the feature extraction module, where the preprocessing module is configured to: performing preprocessing on the to-be-processed image, where the preprocessing includes one or more of resampling, value definition, and normalization.

According to one aspect of the present disclosure, provided is an electronic device, including:

a processor; and

a memory configured to store processor-executable instructions;

where the processor is configured to execute the foregoing image processing method.

According to one aspect of the present disclosure, provided is a computer-readable storage medium, having computer program instructions stored thereon, where when the computer program instructions are executed by a processor, the foregoing image processing method is implemented.

It should be understood that the above general description and the following detailed description are merely exemplary and explanatory, and are not intended to limit the present disclosure.

The other features and aspects of the present disclosure can be described more clearly according to the detailed descriptions of the exemplary embodiments in the accompanying drawings.

### BRIEF DESCRIPTION OF THE DRAWINGS

The accompanying drawings here incorporated in the specification and constituting a part of the specification illustrate the embodiments consistent with the present disclosure and are intended to explain the technical solutions of the present disclosure together with the specification.

FIG. 1 is a flowchart of an image processing method according to an embodiment of the present disclosure.

FIG. 2 is a flowchart of an image processing method according to an embodiment of the present disclosure.

FIG. 3 is a schematic structural diagram of a Unet++ network according to an embodiment of the present disclosure.

FIG. 4 is a schematic structural diagram of a ResVNet network according to an embodiment of the present disclosure.

FIG. 5 is a schematic diagram of a process of redundancy cutting according to an embodiment of the present disclosure.

FIG. 6 is a flowchart of an image processing method according to an embodiment of the present disclosure.

FIG. 7 is a flowchart of an image processing method according to an embodiment of the present disclosure.

FIG. 8 is a flowchart of an image processing method according to an embodiment of the present disclosure.

FIG. 9 is a flowchart of an image processing method according to an embodiment of the present disclosure.

FIG. 10 is a schematic diagram of a first topological structure network according to an embodiment of the present disclosure.

FIG. 11 is a flowchart of an image processing method according to an embodiment of the present disclosure.

FIG. 12 is a schematic diagram of performing connection processing according to an embodiment of the present disclosure.

FIG. 13 is a schematic diagram of an application example according to the present disclosure.

FIG. 14 is a block diagram of an image processing apparatus according to an embodiment of the present disclosure.

FIG. 15 is a block diagram of an electronic device according to embodiments of the present disclosure.

FIG. 16 is a block diagram of an electronic device according to embodiments of the present disclosure.

### DETAILED DESCRIPTION

The various exemplary embodiments, features, and aspects of the present disclosure are described below in detail with reference to the accompanying drawings. The same reference numerals in the accompanying drawings represent elements having the same or similar functions. Although the various aspects of the embodiments are illustrated in the accompanying drawings, unless stated particularly, it is not required to draw the accompanying drawings in proportion.

The special word “exemplary” here means “used as examples, embodiments, or descriptions”. Any “exemplary” embodiment given here is not necessarily construed as being superior to or better than other embodiments.

The term “and/or” herein describes only an association relationship describing associated objects and represents that three relationships may exist. For example, A and/or B may represent the following three cases: only A exists, both A and B exist, and only B exists. In addition, the term “at least one” herein indicates any one of multiple listed items or any combination of at least two of multiple listed items. For example, including at least one of A, B, or C may indicate including any one or more elements selected from a set consisting of A, B, and C.

In addition, numerous details are given in the following detailed description for the purpose of better explaining the present disclosure. A person skilled in the art should understand that the present disclosure may also be implemented without some specific details. In some examples, methods, means, elements, and circuits well known to a person skilled in the art are not described in detail so as to highlight the subject matter of the present disclosure.

It can be understood that the foregoing various method embodiments mentioned in the present disclosure may be combined with each other to form a combined embodiment without departing from the principle logic. Details are not described herein repeatedly due to space limitation.

In addition, the present disclosure further provides an image processing apparatus, an electronic device, a computer-readable storage medium, and a program, which can all be configured to implement any one of the image processing methods provided in the present disclosure. For corresponding technical solutions and descriptions, please refer to the corresponding content in the method section. Details are not described repeatedly.

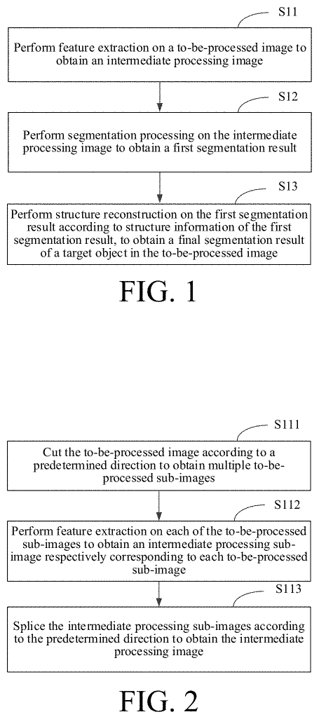

FIG. 1 is a flowchart of an image processing method according to an embodiment of the present disclosure; the method may be applied to an image processing apparatus, and the image processing apparatus may be a terminal device, a server, or other processing devices. The terminal device is a User Equipment (UE), a mobile device, a user terminal, a terminal, a cellular phone, a cordless phone, a Personal Digital Assistant (PDA), a handheld device, a computing device, a vehicle-mounted device, a wearable device, or the like.

In some possible implementations, the image processing method may be implemented by a processor by invoking computer readable instructions stored in a memory.

As shown in FIG. 1, the image processing method includes the following steps.

At step S11, feature extraction is performed on a to-be-processed image to obtain an intermediate processing image.

At step S12, segmentation processing is performed on the intermediate processing image to obtain a first segmentation result.

At step S13, structure reconstruction is performed on the first segmentation result according to structure information of the first segmentation result, to obtain a final segmentation result of a target object in the to-be-processed image. In the embodiments of the present disclosure, the to-be-processed image for image processing may be a three-dimensional image or a two-dimensional image, and may be selected according to the actual situation, which is not limited in the embodiments of the present disclosure. It should be noted that if the to-be-processed image is a three-dimensional image, the to-be-processed image is composed of multiple voxel points; if the to-be-processed image is a two-dimensional image, the to-be-processed image is composed of multiple pixel points. In each subsequent embodiment of the disclosure, a three-dimensional image is taken as an example, and therefore, voxel points are used for description, and details are not described below again. The number of to-be-processed images for image processing is likewise not limited in the embodiments of the present disclosure, and may be one or multiple, and it may be determined according to the actual situation.

The image processing method in the embodiments of the present disclosure may be applied to the processing of lung images, for example, for identifying a target region in a lung image. The target region may be a vascular tree in the lung image, and may also be other organs, lesions, tissues, and the like in the lung image. In one possible implementation, the image processing method in the embodiments of the present disclosure may be applied to a lung cancer lesion resection operation, and a resection region may be determined through the image processing method in the embodiments of the present disclosure. In one example, the image processing method in the embodiments of the present disclosure may be applied to the diagnosis of pulmonary vessel related diseases, and the change of the visual form of the pulmonary vascular tree in a three-dimensional space may be determined through the image processing method in the embodiments of the present disclosure, thereby assisting a doctor in diagnosing related diseases.

It should be noted that the image processing method in the embodiments of the present disclosure is not limited to applications in lung image processing, and may be applied to any image processing. In one example, the image processing method in the embodiments of the present disclosure may be applied to segmentation of vascular structures in other organs or tissues; in one example, the image processing method in the embodiments of the present disclosure may be applied to segmentation of lesions in other organs or tissues. No limitation is made thereto in the present disclosure.

In the image processing method in the embodiments of the present disclosure, segmentation processing is performed after performing feature extraction on the to-be-processed image so as to obtain an initial segmentation result, and based on the initial segmentation result, the structural information included therein may be used for structure reconstruction to obtain the final segmentation result of the target object in the to-be-processed image. Through this process, the final segmentation result is obtained by performing structure reconstruction based on the initial segmentation result; compared with the segmentation result directly through the segmentation processing, the initial segmentation result may be further finely corrected, so that the final segmentation result includes more accurate structured information, and then the integrity and accuracy of the segmentation result is improved, thereby improving the precision of image processing.

The implementation of step S11 is not limited, and may method capable of performing feature extraction on the to-be-processed image may be used as the implementation of step S11. In one possible implementation, a complete to-be-processed image may be directly extracted, and the output result is used as an intermediate processing image. FIG. 2 is a flowchart of an image processing method according to an embodiment of the present disclosure. As shown in the figure, in one possible implementation, step S11 may include the following steps.

At step S111, the to-be-processed image is cut according to a predetermined direction to obtain multiple to-be-processed sub-images.

At step S112, feature extraction is performed on each of the to-be-processed sub-images to obtain an intermediate processing sub-image respectively corresponding to each to-be-processed sub-image.

At step S113, the intermediate processing sub-images are spliced according to the predetermined direction to obtain the intermediate processing image.

In the above process, the predetermined direction for cutting the to-be-processed image is not limited, may be determined according to the actual situation, and is not limited here. In one possible implementation, the to-be-processed image may be a three-dimensional image, including three directions in total: sagittal x, coronal y, and axial z. In one example, the predetermined direction may be the axial z direction, and in this case, the to-be-processed image may be cut along the z direction to obtain multiple corresponding three-dimensional to-be-processed sub-images. In one example, the predetermined direction may be the sagittal x direction, and in this case, the to-be-processed image may be cut along the x direction to obtain multiple corresponding three-dimensional to-be-processed sub-images. In one possible implementation, the to-be-processed may be a two-dimensional image, including two directions in total: sagittal x and coronal y. In one example, the predetermined direction may be the sagittal x direction, and in this case, the to-be-processed image may be cut along the x direction to obtain multiple corresponding two-dimensional to-be-processed sub-images. In one example, the predetermined direction may be the coronal y direction, and in this case, the to-be-processed image may be cut along the y direction to obtain multiple corresponding two-dimensional to-be-processed sub-images. In one example, the predetermined direction may include both the sagittal x direction and the coronal y direction, and in this case, the to-be-processed image may be cut along the x direction and the y direction simultaneously to obtain multiple corresponding two-dimensional to-be-processed sub-images.

The number and size of the multiple to-be-processed sub-images obtained after cutting are likewise not limited, and may be determined according to the actual cutting approach and the size of the to-be-processed image that is cut, and no specific value limitations are made here.

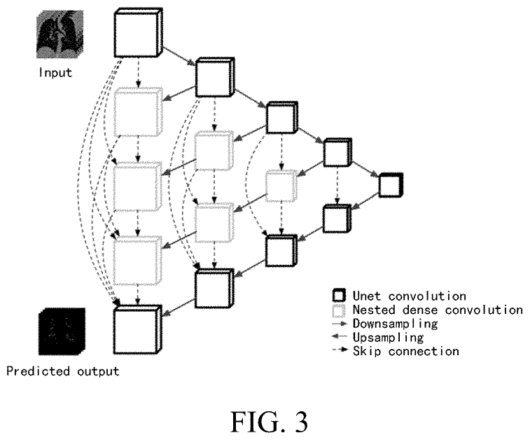

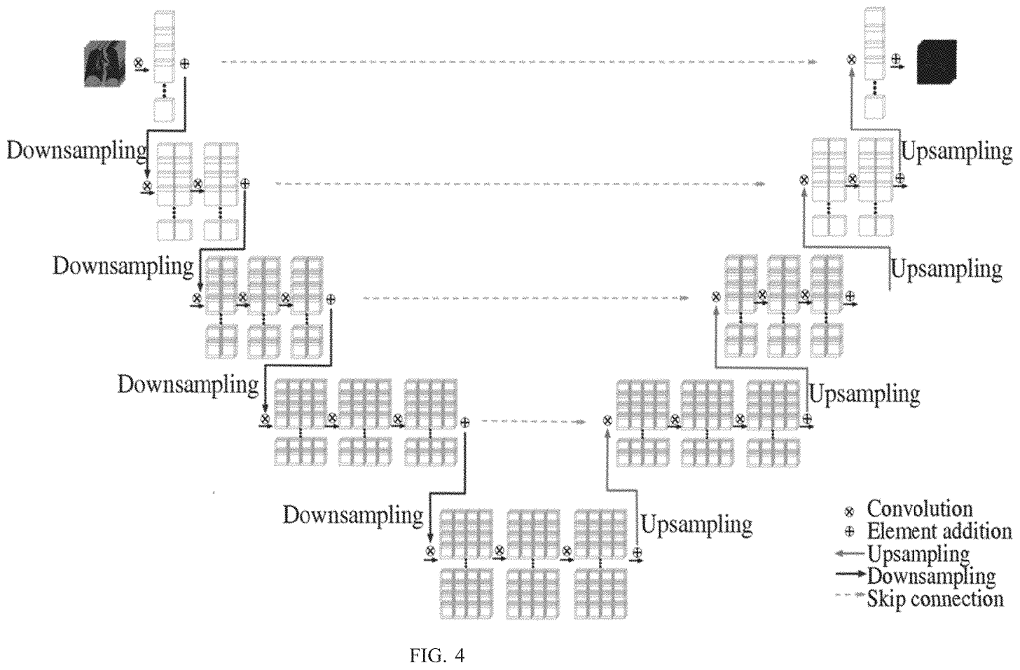

In the above steps, the approach of feature extraction is likewise not limited. In one possible implementation, the feature extraction may be implemented through a neural network. When performing feature extraction through the neural network, which specific neural network is used is not limited here, and can be flexibly selected according to the actual situation. In one possible implementation, the feature extraction may be completed through a 3D convolutional neural network. In one example, the specific process of performing feature extraction on the to-be-processed sub-images through the 3D convolutional neural network may be as follows: a to-be-processed sub-image is input into the 3D convolutional neural network as a single-channel voxel block, and after processing by the 3D convolutional neural network, a corresponding output result may be obtained, i.e., two-channel tensor of the same size as the input to-be-processed sub-image. One of the two channels represents the probability that each voxel point belongs to the background, and the other of the two channels represents the probability that each voxel point belongs to the target object. Since the 3D convolutional neural network has multiple possible implementations, in the embodiments of the present disclosure, which specific 3D convolutional neural network is used is not limited, and may be determined according to the actual situation, and is not limited to the examples proposed in the embodiments of the present disclosure. In one example, the 3D convolutional neural network for feature extraction may be a Unet++ network. FIG. 3 is a schematic structural diagram of a Unet++ network according to an embodiment of the present disclosure; as shown in the figure, in one example, the Unet++ network may be used to generate multilayer outputs with different resolutions and multi-scale sizes by means of multiple downsampling and a corresponding upsampling process and a jump connection process. Combining these multi-layer outputs may obtain the feature extraction results that finally exist in the form of a probability map. In one example, the 3D convolutional neural network for feature extraction may be a ResVNet network. FIG. 4 is a schematic structural diagram of a ResVNet network according to an embodiment of the present disclosure; as shown in the figure, in one example, the ResVNet network may be used to generate multilayer outputs with different resolutions and multi-scale sizes by means of different downsampling and upsampling processes in the above examples, in combination with a jump connection process applicable to this network. Combining these multi-layer outputs may obtain the feature extraction results that finally exist in the form of a probability map.

By cutting the to-be-processed image to obtain multiple to-be-processed sub-images, performing extraction on each of the to-be-processed sub-images respectively, and then splicing the multiple intermediate processing sub-images obtained through feature extraction according to the predetermined direction, a corresponding intermediate processing image is obtained. By means of such a process, the to-be-processed image may be cut into multiple to-be-processed sub-images of appropriate size when the to-be-processed image is too large, thereby effectively reducing the size of an input image for feature extraction and reducing the probability that the accuracy of the feature extraction result is reduced due to the too large input image. Therefore, the precision of feature extraction is improved, so that the obtained intermediate processing image has higher accuracy, and then the precision of the entire image processing process is improved. In addition, the probability of memory overflow caused by the too large to-be-processed image is also reduced, and thus memory consumption is effectively reduced.

It has been proposed in the above embodiments of the disclosure that the number and size of the multiple to-be-processed sub-images obtained in step S111 are not limited, and may be determined according to the actual cutting situation. In fact, the specific implementation of step S111 is likewise not limited, that is, the cutting approach of the to-be-processed is not limited to a certain fixed approach. Any cutting method capable of avoiding the loss of any image information in the to-be-processed image may be used as the implementation of step S111.

In one possible implementation, the implementation of step S111 may be non-redundant cutting; in this case, step S111 may include: determining multiple cutting centers on the to-be-processed image; and cutting the to-be-processed image according to the predetermined direction in accordance with positions of the cutting centers to obtain the multiple to-be-processed sub-images, where each cutting center is located at the center of a corresponding to-be-processed sub-image respectively, and an overlapping region does not exist between adjacent to-be-processed sub-images. In this case, if these to-be-processed sub-images are spliced sequentially in the predetermined direction, said sub-images may be restored into the original complete to-be-processed image. In this non-redundant cutting process, the number of cutting centers is not limited, and may be flexibly selected according to the actual situation, that is, the number of the finally obtained to-be-processed sub-images is not limited. The lengths of the multiple to-be-processed sub-images obtained by cutting in the predetermined direction may be the same or different, that is, during cutting, even cutting may be performed on the to-be-processed image, and uneven cutting may also be performed on the to-be-processed image.

In one possible implementation, the implementation of step S111 may be redundant cutting; in this case, step S111 may include: determining multiple cutting centers on the to-be-processed image; and cutting the to-be-processed image according to the predetermined direction in accordance with positions of the cutting centers to obtain the multiple to-be-processed sub-images, where each cutting center is located at the center of a corresponding to-be-processed sub-image respectively, and an overlapping region exists between adjacent to-be-processed sub-images. In this case, if these adjacent to-be-processed sub-images are spliced in the predetermined direction, in addition to obtaining the complete to-be-processed image, an image block is redundant between any two adjacent to-be-processed sub-images on this complete to-be-processed image. In this redundant cutting process, the number of cutting centers is not limited, and may be flexibly selected according to the actual situation, that is, the number of the finally obtained to-be-processed sub-images is not limited. Besides, in this redundant cutting process, the lengths of the multiple to-be-processed sub-images obtained by cutting in the predetermined direction may be the same or different, that is, during cutting, even cutting may be performed on the to-be-processed image, and uneven cutting may also be performed on the to-be-processed image.

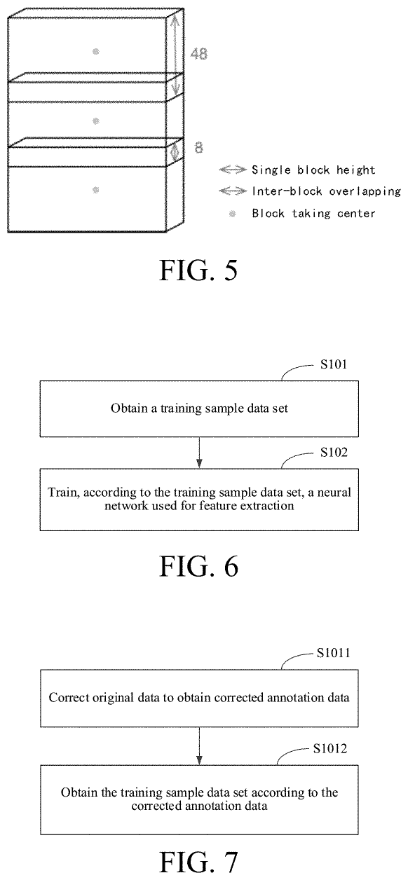

FIG. 5 is a schematic diagram of a process of redundancy cutting according to an embodiment of the present disclosure; as shown in the figure, in one example, the cut to-be-processed image is a three-dimensional image, and the size thereof may be written as z×x×y. In this example, the predetermined direction of the redundant cutting is the z direction, and the cutting performed on the to-be-processed image is even cutting. It can be seen from the figure that the specific process of cutting the to-be-processed image may be: first determining three cutting centers on the to-be-processed image, and then in the z direction, taking a length of 24 individual pixel points above and below the three cutting centers respectively. Therefore, three to-be-processed sub-images with overlapping regions in adjacent positions are finally obtained. The size of each to-be-processed sub-image is 48×x×y, there is an 8×x×y overlapping region between the first to-be-processed sub-image and the second to-be-processed sub-image, and there is also an 8×x×y overlapping region between the second to-be-processed sub-image and the third to-be-processed sub-image.

By using the redundant cutting approach to cut the to-be-processed image, the probability that part of image information related to some target objects is lost due to the cutting of the to-be-processed image is reduced, thereby improving the degrees of completeness and accuracy of the obtained feature extraction result, and then improving the precision and degree of completeness of the final segmentation result, that is, improving the precision of image processing. In one possible implementation, the two approaches, redundant cutting and non-redundant cutting, may also be combined, that is, according to the actual situation, some regions in the to-be-processed image are flexibly selected for redundant cutting, and the remaining regions are used for non-redundant cutting.

Since the implementation of step S111 is not limited, the implementation of step S113 relative thereto is likewise not limited, and may be determined according to the specific implementation process of step S111. In one possible implementation, step S111 may adopt a cutting approach of non-redundant cutting; in this case, in contract to this, the implementation process of step S113 may be: splicing all intermediate processing sub-images in sequence according to the predetermined direction to obtain an intermediate processing image. In one possible implementation, step S111 may adopt a cutting approach of redundant cutting; in this case, in contract to this, the implementation process of step S113 may be: splicing all intermediate processing sub-images in sequence according to the predetermined direction, where for the overlapping region between adjacent intermediate processing sub-images, the average value of the corresponding two adjacent intermediate processing sub-images is taken as the value of the overlapping region. In one example, for the cutting result in the example corresponding to FIG. 5, the splicing process may be: as shown in the figure, the three to-be-processed sub-images obtained after cutting are respectively subjected to feature extraction to obtain three corresponding intermediate processing sub-images; the three intermediate processing sub-images are respectively recoded as an intermediate processing sub-image 1, an intermediate processing sub-image 2, and an intermediate processing sub-image 3; in the z direction, the three intermediate processing sub-images are spliced in sequence; then a corresponding overlapping region exists between the intermediate processing sub-image 1 and the intermediate processing sub-image 2 and is recorded as overlapping region 1, and a corresponding overlapping region exists between the intermediate processing sub-image 2 and the intermediate processing sub-image 3 and is recorded as overlapping region 2. Since the three intermediate processing sub-images may all be presented in the form of probability maps, for the overlapping region 2, the probability value thereof may be the average of the probability value of the intermediate processing sub-image 2 in this region and the probability value of intermediate processing sub-image 3 in this region; for a non-overlapping region, the probability value thereby may directly use the probability value of the intermediate processing sub-image corresponding to the region. In this case, the intermediate processing image corresponding to the complete to-be-processed image may be obtained, and the intermediate processing image exists in the form of a probability map.

In addition to the above embodiments of the disclosure, in the process of step S11, before step S111, the following step may be further included: performing scaling processing on the to-be-processed image in directions other than the predetermined direction according to predetermined parameters. Since feature extraction may be implemented through a neural network, in order to improve the processing efficiency of feature extraction, it is possible to consider unifying the to-be-processed images in size. Therefore, scaling processing may be performed on the to-be-processed images. Since the to-be-processed sub-image input to the neural network is obtained by cutting a to-be-processed image in the predetermined direction, the sizes of these to-be-processed sub-images in the predetermined direction may be unified by adjusting the cutting approach. Therefore, before step S111, it is possible to consider scaling only the to-be-processed image in directions other than the predetermined direction. In one example, the to-be-processed image may be a three-dimensional image, including three directions in total: sagittal x, coronal y, and axial z. The predetermined direction may be the axial z direction, and in this case, the to-be-processed image may be scaled according to predetermined parameters in the x and y directions. In one example, the to-be-processed image may be a two-dimensional image, including two directions in total: sagittal x and coronal y. The predetermined direction may be the sagittal x direction, and in this case, the to-be-processed image may be scaled according to predetermined parameters in the y direction. The predetermined parameters may be flexibly determined according to the actual situation, and are not limited here. Any predetermined parameter capable of making the to-be-processed image suitable for subsequent feature extraction after scaling is applicable to this method. In one example, the to-be-processed image may be a three-dimensional image, including three directions in total: sagittal x, coronal y, and axial z. The predetermined direction may be the axial z direction, the predetermined parameter may be a multiple of 16 in the x direction and a multiple of 16 in the y direction, and in this case, the to-be-processed image may be scaled according to predetermined parameters in the x and y directions, that is, the to-be-processed image rounded up to an integer multiple of 16 in both the x and y directions.

It can be seen from the above embodiments of the disclosure that because feature extraction is required in the image processing method, in one possible implementation, feature extraction may be implemented through the neural network, and the specific network structure of the neural network needs to be obtained by means of training. Therefore, the method proposed in the embodiments of the present disclosure may include, before step S11, step S10 of training the neural network. The specific implementation of S10 is not limited. FIG. 6 is a flowchart of an image processing method according to an embodiment of the present disclosure; as shown in the figure, in one possible implementation, step S10 may include the following steps.

At step S101, a training sample data set is obtained.

At step S102, a neural network used for feature extraction is trained according to the training sample data set.

The implementation of step S101 is not limited. FIG. 7 is a flowchart of an image processing method according to an embodiment of the present disclosure. As shown in the figure, in one possible implementation, step S101 may include the following steps.

At step S1011, original data is corrected to obtain corrected annotation data.

At step S1012, the training sample data set is obtained according to the corrected annotation data.

In one possible implementation, the original data may be mask annotation data generated according to a training data generation method in the conventional neural network. In one example, when the target object is a pulmonary vascular tree, due to the complex relationship of pulmonary blood vessels, the original data generated through the training data generation method in the convention neural network often has low quality, thereby influencing the degree of precision of the finally trained neural network. Therefore, in one possible implementation, the quality of the training data may be improved by modifying the original data to obtain the annotation data. In one example, the implementation of step S1011 may be as follows: generating mask annotation data through ac conventional method, and manually modifying same by professionals to obtain annotation data with high precision that may be used for training, where the implementation of generating the mask annotation data through the conventional method is not limited. In one example, a mask threshold may be set to 0.02 when generating the mask annotation data, voxel points higher than the threshold are foreground and annotated as 1, while voxel points lower than the threshold are background and annotated as 0.In one possible implementation, when the training sample data set is obtained through step S24, the range of data values in the training sample data set may be limited, and the specific limitation approach is not limited. In one example, the value range during training may be limited to [−0.5, 0.5].

The implementation of step S1012 is likewise not limited. In one possible implementation, the corrected annotation data may include multiple complete training sample images; the number of the complete training sample images included in the corrected annotation data is not limited here, and may be flexibly selected according to the actual situation. In one possible implementation, a complete training sample image may include a complete lung image in which the target object has been corrected and annotated. In one example, the target object may be a vascular tree, and in this case, the complete training sample image may include a lung image in which the vascular tree has been corrected and annotated; moreover, this lung image is not cut and is an original complete image.

Therefore, in one possible implementation, step S1012 may include: directly taking all the complete training sample images as the training sample data set. However, it can be seen from the above embodiments of the disclosure that since the object for feature extraction may be a lung sub-image obtained by cutting the lung image, the image input to the neural network for feature extraction may also be a lung sub-image, i.e., a lung sub-image obtained based on the complete lung image after cutting. In order to make the neural network suitable for feature extraction of the cut lung sub-images, in one possible implementation, the images included in the training sample data set for training the neural network may also be the training sample sub-images obtained after cutting the complete training sample image. Therefore, in one possible implementation, step S1012 may include: cutting the complete training sample image to obtain the training sample sub-images, which are taken as the training sample data set. In one example, cutting the complete training sample image to obtain the training sample sub-images includes:

scaling the complete training sample images to preset sizes in directions other than the predetermined direction, keeping the sizes of the complete training sample image unchanged in the predetermined direction, and making the sizes of the complete training sample image uniform, to obtain scaled complete training sample images;

cascading all the scaled complete training sample images in the predetermined direction to obtain cascaded training sample images; and

randomly cutting and sampling the cascaded training sample images to obtain the training sample sub-images.

In one possible implementation, the complete training sample images are scaled to the preset sizes, and the specific size values thereof are not limited. In one example, the complete training sample images are three-dimensional images, including three directions in total: sagittal x, coronal y, and axial z, where the predetermined direction is z direction, and the preset sizes for scaling in the sagittal x and coronal y directions are all 320. Therefore, a complete training sample image with size of z×x×y is scaled in the x and y directions, and the size of the obtained scaled complete training sample image is z×320×320.

In one example, the process of cascading all the scaled complete training sample images in the predetermined direction, to obtain the cascaded training sample images is as follows: in the examples of the present disclosure, the total number of the complete training sample images is n; n voxel blocks with size of zᵢ×320×320, i.e., n scaled completed training sample images, are obtained by scaling the n complete training sample images through the above examples, where zᵢ represents the size of the i^{th} complete training sample in the z direction, and the value of i ranges from 1 to n. Cascaded voxel blocks with dimensions of n×z×320×320 are obtained by cascading the n individual voxel blocks in the z direction, and a value range that is that optional in the z direction when performing random sampling in the z direction is determined according to the sizes of the n scaled complete training sample images in the z direction.

After the above cascaded training sample images are obtained, the cascaded training sample images may be randomly cut and sampled to obtain the training sample sub-images. In one example, the obtained cascaded training sample images are the cascaded training samples in the above examples of the disclosure. In this case, the cascaded training sample images may be randomly sampled along the z axis. It should be noted that the process of random sampling is random, but all the finally obtained training sample sub-images need to include training data in the complete training sample images corresponding to all the annotation data. In one example, the sampling process is as follows: first, an integer j is generated according to a random value, where the integer j represents the complete training sample image after the j^{th} scaling selected from the cascaded training sample images; and then, randomly calculating the coordinates of sampling centers in the z-axis direction of the complete training sample image after the j^{th} scaling, and cutting a voxel block with a preset height value from the complete training sample image after the j^{th} scaling. In one example, the preset height value is 16.

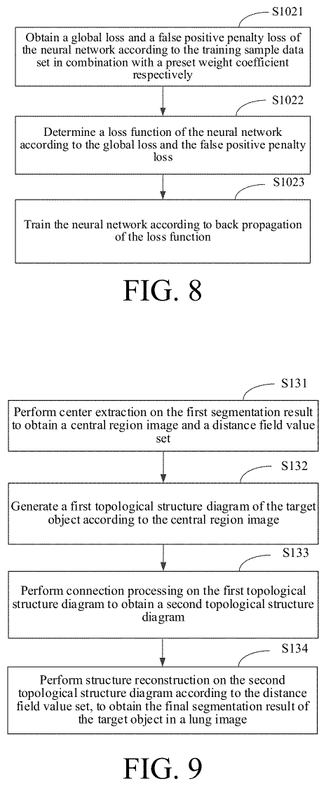

By means of the above examples of the disclosure, the training sample data set is obtained; the neural network used for feature extraction is trained through step S102 according to the obtained training sample data set; the implementation of step S102 is not limited. FIG. 8 is a flowchart of an image processing method according to an embodiment of the present disclosure; as shown in the figure, in one possible implementation, step S102 includes the following steps.

At step S1021, a global loss and a false positive penalty loss of the neural network are respectively obtained according to the training sample data set in combination with a preset weight coefficient.

At step S1022, a loss function of the neural network is determined according to the global loss and the false positive penalty loss.

At step S1023, the neural network is trained according to back propagation of the loss function.

The implementation of step S1021 is not limited. In one possible implementation, the implementation of step S1021 includes: obtaining the global loss of the neural network according to the training sample data set in combination with a first weight coefficient; and obtaining the false positive penalty loss of the neural network according to the training sample data set in combination with the first weight coefficient and a second weight coefficient.

In one possible implementation, obtaining the global loss of the neural network according to the training sample data set in combination with the first weight coefficient includes: increasing the loss weight of the target object by adjusting the first weight coefficient, to obtain the global loss of the neural network. In one example, the specific implementation of the global loss of the neural network is as follows:

$${L}_{1} ( W ) = - \frac{1}{\vert {Y}_{+} \vert} {\sum }_{j ∈ {Y}_{+}} log P ( {y}_{j} = 1 \vert X ; W ) - \frac{1}{\vert {Y}_{-} \vert} {\sum }_{j ∈ {Y}_{-}} log P ( {y}_{j} = 0 \vert X ; W ) \qquad ( 1 )$$

where, L₁(W) is the global loss of the neural network; Y₊ is a positive sample set; Y₋ is a negative sample set; P(Yⱼ=1|X;W) is a portability value of predicting that yⱼ is a positive sample; and P(yⱼ=0|X;W) is a portability value of predicting that yⱼ is a negative sample.

Because the target object is taken as the foreground, it accounts for a small proportion of the entire lung image. If an ordinary global loss function is used, it is easy to cause an over-segmentation in the entire neural network when performing feature extraction on the image due to the imbalance of the foreground and background proportions. By introducing the two first weight coefficients Y₊ and Y₋, it is possible to give a greater weight to the loss caused by the target object with a smaller proportion. In addition, by adopting the global loss function in the above disclosed example, regardless of the specific size of the training data set, the balance process between the target object and the background may be guaranteed to have value stability, that is, the gradient stability of the training process may be improved.

In one possible implementation, obtaining the false positive penalty loss of the neural network according to the training sample data set in combination with the first weight coefficient and the second weight coefficient includes: obtaining the false positive penalty loss used for punishing the wrong prediction of the neural network by introducing the second weight coefficient based on the first weight coefficient. In one example, the specific implementation of the false positive penalty loss of the neural network is as follows:

$${L}_{2} ( W ) = - \frac{{γ}_{1}}{\vert {Y}_{+} \vert} {\sum }_{j ∈ {Y}_{f +}} log P ( {y}_{j} = 0 \vert X ; W ) - \frac{{γ}_{2}}{\vert {Y}_{-} \vert} {\sum }_{j ∈ {Y}_{f -}} log P ( {y}_{j} = 1 \vert X ; W ) \\ {γ}_{1} = 0.5 + \frac{1}{\vert {Y}_{f +} \vert} {\sum }_{j ∈ {Y}_{f +}} \vert log P ( {y}_{j} = 0 \vert X ; W ) - 0.5 \vert \\ {γ}_{2} = 0.5 + \frac{1}{\vert {Y}_{f -} \vert} {\sum }_{j ∈ {Y}_{f -}} \vert log P ( {y}_{j} = 1 \vert X ; W ) - 0.5 \vert \qquad ( 2 )$$

where L₂(W) is the false positive penalty loss of the neural network; Y_{f+} is a false positive prediction set; Y_{f-} is a false negative prediction set; Y₊ is a positive sample set; Y₋ is a negative sample set; P(yⱼ=1|X;W) is a portability value of predicting that yⱼ is a positive sample; and P(yⱼ=0|X;W) is a portability value of predicting that yⱼ is a negative sample; γ₁ is a weight coefficient for false positive prediction; γ₂ is a weight coefficient for false negative prediction; and the values of γ₁ and γ₂ are based on an absolute value of a difference between a wrong prediction probability and a median value. The value of the median value is flexibly determined according to the category of a task. In the example of the present disclosure, the value of the median value is 0.5.

It can be seen from the above examples of the disclosure that because the target object is taken as the foreground, it accounts for a small proportion of the entire lung image. If an ordinary global loss function is used, it is easy to cause an over-segmentation in the entire neural network when performing feature extraction on the image due to the imbalance of the foreground and background proportions. Therefore, the prediction results generated by the neural network in the training process often have a high false positive rate and a low recall rate. In order to alleviate the problem of the high false positive rate and low recall rate, by introducing the two second weight coefficients γ₁ and γ₂, it is possible to punish the wrong prediction of the neural network, thereby reducing the false positive rate of the neural network in the prediction process, and improving the training accuracy of the neural network.

Based on the above examples of the disclosure, in one possible implementation, the implementation of step S1022 is: obtaining the loss function of the neural network by adding the global loss function and the false positive penalty loss function, i.e., L(W)=L₁(W)+L₂(W), where L(W) is the loss function of the neural network.

In the process of the training the neural network, in order to adjusting the parameters of the neural network through the above loss function, it is also possible to evaluate the advantages and disadvantages of the trained neural network through some evaluation functions. What evaluation functions are specifically selected is not limited, and may be flexibly selected according to the actual situation. In one possible implementation, a Dice function is used as the evaluation function. In one example, the specific expression of the Dice function is:

$$D = \frac{{\sum }_{i ∈ V} {p}_{i} \cdot {l}_{i}}{{\sum }_{i ∈ V} {p}_{i} + {\sum }_{i ∈ V} {l}_{i}} \qquad ( 3 )$$

where D is an evaluation result, V represents all voxel points in the lug image, Pᵢ is the probability that the i^{th} individual voxel point is predicted as the target object, and lᵢ is the actual label of the i^{th} individual prime point.

By obtaining the global loss and the false positive penalty loss of the neural network according to the training sample data set in combination with the preset weight coefficients respectively, then determining the loss function of the neural network based on the global loss and the false positive penalty loss, and finally training the neural network based on the back propagation of the loss function, the problem that the trained neural network has a high false positive rate and a low recall rate due to the small proportion of the target object in the overall picture can be effectively alleviated. Therefore, the degree of accuracy of the trained neural network can be improved, thereby improving the precision of the intermediate processing image obtained by performing feature extraction on the to-be-processed image, and then improving the precision of the final segmentation result and the accuracy of image processing.

After the intermediate processing image is obtained in any combination form of the above embodiments of the disclosure, segmentation processing may be performed on the intermediate processing image through step S12, to obtain a first segmentation result. The implementation of step S12 is likewise not limited. Any approach capable of segmenting the intermediate processing image to obtain the first segmentation result can be used as the implementation form of step S12.

In one possible implementation, step 12 includes: performing segmentation processing on the intermediate processing image by means of Grow Cut, to obtain the first segmentation result, where the Grow Cut is implemented in a graphic processing unit through a deep learning framework. The Grow Cut is an interactive image segmentation method. In one example, the specific process of using the Grow Cut to segment the intermediate processing image to obtain the first segmentation result is as follows:

First, a high threshold and a low threshold of a seed point in the Grow Cut method is set; the specific set values are not limited here, and is selected according to the actual situation. After the high and low thresholds of the seed point are set, points below the low threshold are specified as background seed points, that is, representing a background region where a non-target object is located, and are marked as 0; points above the high threshold are specified as foreground seed points, that is, representing a region where the target object is located, and are marked as 1; the intensity value of the seed points is set to 1; as proposed in the above embodiments of the disclosure, the intermediate processing image may be a two-channel tensor, one of the two channels represents the probability that each voxel point belongs to the background, and the other of the two channels represents the probability that each voxel point belongs to the target object, and therefore, a two-channel initial state vector of each voxel point in the intermediate processing image is obtained through the above settings.

After the two-channel initial state vector of each voxel point in the intermediate processing image is obtained, a window size of a neighbor range is set, and the seed points are taken as starting points to compare the states of neighbor points in sequence; if the following condition is satisfied:

$$g ( {‖ {\vec{C}}_{p} - {\vec{C}}_{q} ‖}^{2} ) \cdot {θ}_{q}^{t} > {θ}_{p}^{t} \\ g ( x ) = 1 - \frac{x}{max {‖ \vec{C} ‖}^{2}} \qquad ( 4 )$$

where p is a voxel point representing a guardian, q is a voxel point representing an intruder, \vec{C}ₚ is a feature vector of the voxel point representing the guardian, \vec{C}_{q} is a feature vector of the voxel point representing the intruder, ∥\vec{C}ₚ−\vec{C}_{q}∥² is a distance between the feature vectors of the voxel point representing the guardian and the voxel point representing the intruder, θₚ^{t} is an energy value of the voxel point representing the guardian, θ_{q}^{t} is an energy value of the voxel point representing the intruder, g(x) is a function that decreases monotonically with x between [0, 1], and is not limited to the above form, and max∥\vec{C}∥ is a maximum value that the feature vectors of the voxel points can take.

The voxel point representing the intruder has more energy than the voxel point representing the guardian; in this case, the voxel point representing the intruder may annex the voxel point representing the guardian, and in this case, the feature vector of the corresponding pixel point may be updated. This comparison process is repeated continuously until the feature vector of each voxel point no longer changes, and in this case, the obtained result is the segmentation result of the intermediate processing image by means of the Grow Cut, i.e., the first segmentation result. In the embodiments of the present disclosure, the voxel point segmented into the target object may be regarded as the voxel point representing the guardian, and the voxel point segmented into the background may be regarded as the voxel point representing the intruder; after the seed point is selected, it is possible to select a certain voxel point representing the target object as a starting voxel point for segmentation, and then to select, according to a set neighbor range, a voxel point with a distance from the seed point within the neighbor range; these points can be regarded as the neighbor points of the seed point, and compared with the seed point through the above formula to determine whether the voxel points in the neighbor range should be divided into voxel points representing the guardian or should be divided the voxel points representing the intruder, that is, these points can be taken as voxel points representing the target object or the voxel points representing the background. The above process is repeated continuously until the segmentation of the entire intermediate processing image is completed to obtain the first segmentation result.

In one possible implementation, the Grow Cut may be implemented by a Central Processing Unit (CPU).However, through the above examples of the disclosure, it can be seen that in one possible implementation, when the specific calculation process in the process of segmenting the intermediate processing image by means of the Grow Cut is implemented, this calculation process may be implemented in the form of a convolution operation. When calculation is performed through the Grow Cut in the form of the convolution operation, a deep learning framework is used. In one example, the deep learning framework is PyTorch, and the entire Grow Cut process is processed by a Graphic Processing Unit (GPU); because the GPU has a higher operation speed in image processing, when performing segmentation processing on the intermediate processing image by means of the Grow inCut, the speed of step S12 is greatly improved by implementing the Grow Cut in the GPU through the deep learning framework, so that the speed of the entire image processing method can be effectively improved.

In one possible implementation, the intermediate processing image is also segmented by means of other algorithms to obtain the first segmentation result, which are not listed here one by one, and is flexibly selected according to the actual situation.

After the first segmentation result is obtained through any combination form of the above embodiments of the disclosure, structure reconstruction may be performed on the first segmentation result through step S13, thereby obtaining a final segmentation result of the target object in the to-be-processed image. The implementation form of step S13 is likewise not limited. Any approach capable of performing structure reconstruction based on the first segmentation result to obtain the final segmentation result of the target object can be used as the implementation form of step S13.

FIG. 9 is a flowchart of an image processing method according to an embodiment of the present disclosure. As shown in the figure, in one possible implementation, step S13 may include the following steps.

At step S131, center extraction is performed on the first segmentation result to obtain a central region image and a distance field value set. The distance field value set is a set of distance field values between all voxel points on the central region image and a boundary of the target object in the first segmentation result.

At step S132, a first topological structure diagram of the target object is generated according to the central region image.

At step S133, connection processing is performed on the first topological structure diagram to obtain a second topological structure diagram.

At step S134, structure reconstruction is performed on the second topological structure diagram according to the distance field value set, to obtain the final segmentation result of the target object in the to-be-processed image.

The implementation of step S131 is not limited. In one possible implementation, the implementation of step S131 is as follows: the central region image reflecting a truck position where the target object is located in the first segmentation result is obtained by performing center extraction on the first segmentation result; in this case, the shortest distance between each voxel point in the central region image and the boundary of the target object in the first segmentation result is calculated in sequence, then the shortest distance between each voxel point in the central region image and the boundary of the target object is be recorded as the distance field value of the voxel point; statistics are collected about the distance field values of the voxel points in all the central region images in one set, then the statistical set is regarded as a distance field value set.

In the above embodiments of the disclosure, the approach of performing center extraction on the first segmentation result is not limited, and any method capable of obtaining the center region image reflecting the trunk position where the target object is located in the first segmentation result can be used as the implementation of the center extraction. In one possible implementation, center extraction is performed on the first segmentation result by means of a medial axis transformation function (medial axis),In one example, the target object of the to-be-processed image is a vascular tree in a lung image. In this case, in the examples of the present disclosure, the specific process of step S131 is as follows: center extraction is performed on the first segmentation result through the medial axis to generate a centerline of the vascular tree in the lung image; in this case, statistics are collected about the shortest distance between each voxel point on the centerline and the boundary of the vascular tree in the first segmentation result in sequence, and the statistical result is expressed in the form of a set to obtain the distance field value set.

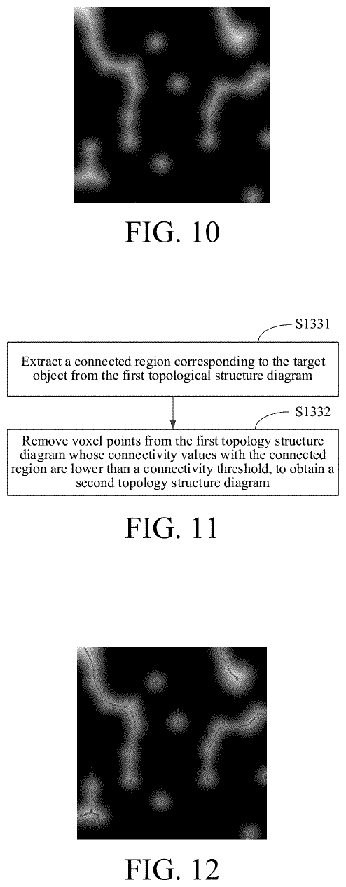

The implementation of step S132 is likewise not limited, and any approach capable of collecting statistics about the topological structure of the central region image to generate the first topological structure diagram can be used as the implementation form of step S132. In one possible implementation, the central region image is processed through a networkx tool to generate a topological structure diagram. FIG. 10 is a schematic diagram of a first topological structure network according to an embodiment of the present disclosure. As shown in the figure, in one example, the target object of the to-be-processed image is a vascular tree in a lung image. In this case, it can be seen from the figure that the first topological structure diagram generated in step S132 is a topological structure diagram of a pulmonary vascular tree.

The implementation of step S133 is likewise not limited, and any approach capable of refining the first topological structure diagram based on a connection structure of the first topological structure diagram to obtain a second topological structure diagram can be used as the implementation form of step S133. That is, the implementation of the connection processing is not limited, and any approach capable of appropriately correcting the connectivity of the first topological structure diagram based on a connected state in the first topological structure diagram can be used as the implementation of the connection processing. FIG. 11 is a flowchart of an image processing method according to an embodiment of the present disclosure. As shown in the figure, in one possible implementation, step S133 may include the following steps.

At step S1331, a connected region corresponding to the target object from the first topological structure diagram is extracted.

At step S1332, voxel points from the first topological structure diagram whose connectivity values with the connected region are lower than a connectivity threshold are removed, to obtain a second topological structure diagram.

The main purpose of step S133 is to correct the generated first topological structure diagram; since there may be a large number of noise points in the first topological structure diagram, these noise points need to be removed, to obtain the second topological structure diagram that is more accurate and can better reflect the connectivity and integrity of the target object. Therefore, in one possible implementation, statistics are collected about the connected regions where the target objects in the first topological structure diagram are located; since these isolated weakly-connected regions are likely to be noise points, the isolated weakly-connected regions in the first topological structure diagram are removed to obtain the second topological structure diagram. The approach of determining which regions in the first topological structure diagram are the isolated weakly-connected regions is not limited, and can be flexibly selected according to the actual situation. In one possible implementation, one connectivity threshold is set, and the specific value of this connectivity threshold is set according to the actual situation, which is not limited here. After the connectivity threshold is set, a connectivity value between each voxel point and the connected region in the first topological structure diagram is calculated respectively and compared with the connectivity threshold, where voxel points with connectivity values lower than the connectivity threshold are considered as weakly connected regions and need to be removed from the first topological structure diagram. FIG. 12 is a schematic diagram of performing connection processing according to an embodiment of the present disclosure. As shown in the figure, in one example, the target object of the to-be-processed image is a vascular tree in a lung image, and the first topological structure diagram is a schematic diagram in FIG. 10. In this case, it can be seen from FIG. 12 that there are several more isolated points in addition to the connected tree structures, and in this case, these isolated points may be removed, and the obtained topological structure diagram may be the second topological structure diagram.

The implementation of step S134 is likewise not limited, and any approach capable of performing structure reconstruction based on the distance field value set and the second topological structure diagram can be used as the implementation form of step S134. In one possible implementation, step S134 includes: performing drawing by taking each point in the second topological structure diagram as a sphere center and each distance field value in the distance field value set as a radius, and adding the overlapping region included in the drawing to the second topological structure diagram, to obtain the final segmentation result of the target object in the to-be-processed image. In one example, the target object of the to-be-processed image is a vascular tree in a lung image, then in this case, the second topological structure diagram is a vascular tree topology diagram subjected to refinement processing. In this case, the specific process of step S134 is as follows: a sphere is drawn by taking each point on the centerline of the vascular tree topology subjected to refinement processing as a sphere center and the distance recorded in the distance field as a radius, thus several drawn spheres with different sphere centers are obtained; statistics are collected about overlapping regions among these different drawn spheres, and these regions are combined with the centerline of the vascular tree topology, so that a complete vascular tree structure is obtained as the final segmentation result of the target object in the to-be-processed image.

The above structured reconstruction process is structured reconstruction performed based on the first segmentation result, that is, performing structured reconstruction based on real data rather than performing structured reconstruction for synthetic data. Therefore, the obtained final segmentation has higher authenticity. In addition, the central region image and the distance field value set of the first segmentation result are obtained by means of center extraction, the first topological structure diagram is generated based on the central region image, and connection processing is performed on the first topological structure diagram to obtain a second topological structure diagram. This process effectively improves the connectivity of the first segmentation result, removes the noise points in the first segmentation result, effective corrects the first segmentation result, and improves the accuracy of the obtained final segmentation result. In addition, the final segmentation result obtained performing structured reconstruction on the target object by using the second topological structure diagram and the distance field value set effectively reflects the information of each node and branch of the target object, and has high precision.

In one possible implementation, before step S11, the method further includes: performing preprocessing on the to-be-processed image, where the preprocessing includes one or more of resampling, value definition, and normalization. In one possible implementation, in addition to the above several possible implementation forms, the preprocessing approach also includes other forms, which may be flexibly selected according to the actual situation. Any approach capable of improving the overall precision of the image processing method can be used as the implementation form of preprocessing. In one example, the process of resampling the to-be-processed image is: resampling full data of the to-be-processed image at a fixed resolution by using a linear interpolation method, and mapping same to an isomorphic resolution. In one example, the isomorphic resolution is 1 mm×1 mm×1 mm. The specific limited value for value limitation of the to-be-processed image is not limited. In one example, the original image value of the to-be-processed image is limited to a range of [−1500.0, 300.0].Similarly, normalization is performed on the to-be-processed image, and the normalization result is likewise not limited. In one example, the to-be-processed image is finally normalized to [0, 1].

By performing preprocessing on the to-be-processed image, the processing efficiency of subsequently performing feature extraction, segmentation processing, and structure reconstruction on the to-be-processed image in sequence is improved, and the time of the entire image processing process is shortened; moreover, the degree of accuracy of image segmentation is also improved, thereby improving the precision of the image processing result.

Application Scenario Examples

Vascular tree segmentation is a hot research topic in the field of medical image analysis: precise vessel analysis has extremely important research and application values for medical diagnosis, treatment planning and clinical effect evaluation. Pulmonary blood vessels serve as an important basis for common pulmonary vascular diseases such as lobectomy and pulmonary embolism, and the accurate segmentation is important for the diagnosis and treatment of lung-related diseases.

However, the lung of a human body is an exchange site of metabolism-produced gases, and includes abundant tracheal and vascular tissues, so the structure is relatively complex; moreover, due to the influences of factors such as noise, contrast, and volume effects, CT images have problems such as poor contrast and blurred boundary, and the arteries and veins of the lung are intertwined with and accompanied by each other, so the difficulty of segmentation is further increased. Therefore, the segmentation method for vascular trees in lung images still faces the problems and disadvantages such as slow speed, poor segmentation precision, and misjudgment at the boundary. Although some methods have been improved to some extent, there are still some practical problems, for example, over-segmentation of a lung edge region is common, the vascular trees are prone to breaks during segmentation, etc.

Therefore, a segmentation method with high precision and complete segmentation results can greatly reduce the workload of doctors, thereby improving the treatment effect of lung-related diseases.

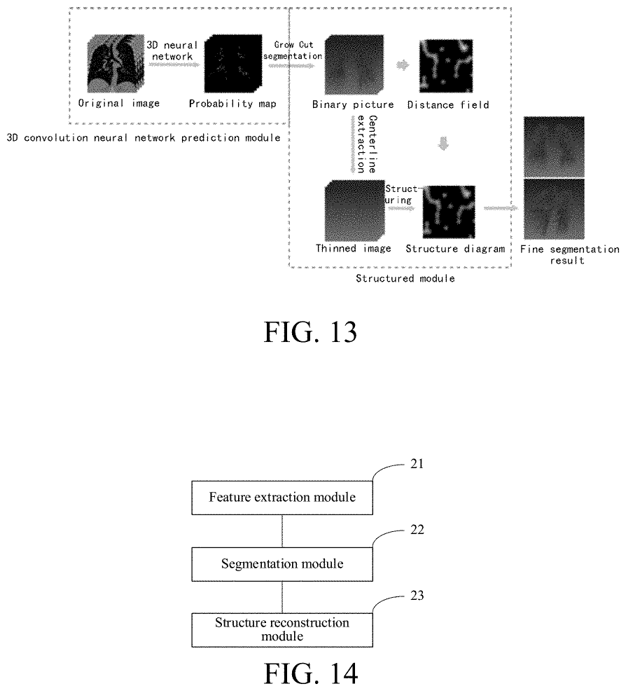

FIG. 13 is a schematic diagram of an application example according to the present disclosure. As shown in the figure, the embodiments of the present disclosure provide an image processing method. It can be seen from the figure that the specific process of performing vascular tree segmentation on a lung image through this image processing method is as follows:

first, a complete three-dimension lung image (the three-dimensional lug image in this example is a single-channel grey-scale image with a size of z×x×y) is subjected to data preprocessing and then input to a 3D neural network for feature extraction, to obtain a two-channel output probability map, where in the two-channel output probability map, one channel represents the probability that each voxel point belongs to the pulmonary blood vessel, and the other channel represents the probability that each voxel point belongs to the background. The size of the two-channel output probability map is z×x×y.

In the examples of the present disclosure, the 3D neural network used is specifically a VNet convolutional neural network. The specific process performing feature extraction on the three-dimensional lung image in the convolutional neural network is:

first scaling the three-dimensional lung image with a size of z×x×y in two directions: the sagittal x direction and the coronal y direction, so that the sizes of the three-dimensional lung image are multiples of 16 in both the x and y directions, which are respectively recorded as x′ and y′; and then, cutting the three-dimensional lung image in the axial z direction. In the examples of the present disclosure, the height of each three-dimensional lung sub-image obtained by cutting in the z direction should be 48 voxels, and any two adjacent three-dimensional lung sub-images have an overlap of 8 voxels in the z direction, thus the size of each obtained three-dimensional lung sub-image is 48×x′×y′.

After the cutting of the three-dimensional lung image is completed, each of the three-dimensional lung sub-images obtained by cutting is respectively processed by a VNet convolutional neural network to obtain multiple intermediate processing sub-images. These intermediate processing sub-images are all two-channel voxel blocks with a size of 48×x′×y′, and the two channels respectively represent the probabilities that each voxel point belongs to the background and the vascular tree.

These intermediate processing sub-images are reversely spliced according to the three-dimensional lung image cutting approach. Since adjacent three-dimensional lung sub-images have an overlap of 8 voxels in the z direction during cutting, adjacent intermediate-processing sub-images among these intermediate-processing sub-images also have an overlap of 8 voxels in the z direction. In the case, the probability at overlapping voxel points is the average of corresponding voxel point probabilities in two corresponding intermediate processing sub-images, and the probability values at the remaining voxel points may be based on the probabilities of the corresponding voxel points of the corresponding intermediate processing sub-image.

The intermediate processed image after splicing is reversely scaled in the x and y directions according to the previous scaling approach, and restored to the original size to obtain the two-channel output probability map with a size of z×x×y.

After the two-channel output probability map with a size of z×x×y is obtained, the two-channel output probability map may be segmented by means of a Grow Cut algorithm to obtain a binary picture. In the examples of the present disclosure, the Grow Cut algorithm may be implemented in a GPU through a PyTorch framework, that is, the process of converting the probability map into a binary picture may be performed by means of the GPU.

After the above binary picture is obtained, the binary picture may be processed through the medial axis to generate a centerline image of the vascular tree; in addition, the distance field value of each voxel point representing the target object and the center line in the binary picture is recorded to obtain a distance field value set. Then, a vascular tree topology structure is generated for the generated centerline image of the vascular tree through NetworkX, and statistics are collected about connected regions of the vascular tree in the generated vascular tree topology structure, and voxels in the isolated weakly-connected region on the edge of the vascular tree are removed; because this part is most likely a noise point, a main branch and trunk diagram of the vascular tree with strong connectivity may be obtained finally.

Then, spheres are drawn by taking each point on the centerline of the main branch and trunk diagram of the vascular tree with strong connectivity as a sphere center and the distance recorded in the distance field value set as a radius; the spheres overlap each other to form a complete vascular tree structure, which represents the final segmentation result of the pulmonary vascular tree in the three-dimensional lung image.

By using the image processing method of the present disclosure, the overall segmentation precision of the pulmonary vascular tree can be improved, and false positives can be reduced; moreover, more accurate structured information of the pulmonary vascular tree, including branches, endpoints, etc. is obtained, so as to further refine the pulmonary blood vessel segmentation results. Meanwhile, the structured information obtained in the process of structure reconstruction can also be used to assist the diagnosis of other lung diseases.

It should be notated that the image processing method according to the embodiments of the present disclosure is not limited to the above lung image processing, and may be applied to any image processing. No limitation is made thereto in the present disclosure.

It can be understood that the foregoing various method embodiments mentioned in the present disclosure may be combined with each other to form a combined embodiment without departing from the principle logic. Details are not described herein repeatedly due to space limitation.

A person skilled in the art can understand that, in the foregoing methods of the specific implementations, the order in which the steps are written does not imply a strict execution order which constitutes any limitation to the implementation process, and the specific order of executing the steps should be determined by functions and possible internal logics thereof.

FIG. 14 is a block diagram of an image processing apparatus according to embodiments of the present disclosure. As shown in the figure, the image processing apparatus includes:

a feature extraction module 21, configured to perform feature extraction on a to-be-processed image to obtain an intermediate processing image;

a segmentation module 22, configured to perform segmentation processing on the intermediate processing image to obtain a first segmentation result; and

a structure reconstruction module 23, configured to perform structure reconstruction on the first segmentation result according to structure information of the first segmentation result, to obtain a final segmentation result of a target object in the to-be-processed image.

In one possible implementation, the feature extraction module includes: a cutting sub-module, configured to cut the to-be-processed image according to a predetermined direction to obtain multiple to-be-processed sub-images; a feature extraction sub-module, configured to perform feature extraction on each of the to-be-processed sub-images to obtain an intermediate processing sub-image respectively corresponding to each to-be-processed sub-image; and a splicing sub-module, configured to splice all the intermediate processing sub-images according to the predetermined direction to obtain the intermediate processing image.

In one possible implementation, the cutting sub-module is configured to: determine multiple cutting centers on the to-be-processed image; and cut the to-be-processed image according to the predetermined direction in accordance with positions of the cutting centers to obtain the multiple to-be-processed sub-images, where each cutting center is located at the center of a corresponding to-be-processed sub-image respectively, and an overlapping region exists between adjacent to-be-processed sub-images.

In one possible implementation, the apparatus further includes a scaling sub-module before the cutting sub-module, where the scaling sub-module is configured to: perform scaling processing on the to-be-processed image in directions other than the predetermined direction according to predetermined parameters.

In one possible implementation, the apparatus further includes a training module before the feature extraction module, where the training module includes: a sample obtaining sub-module, configured to obtain a training sample data set; and a training sub-module, configured to train, according to the training sample data set, a neural network used for feature extraction.

In one possible implementation, the sample obtaining sub-module is configured to: correct original data to obtain corrected annotation data; and obtain the training sample data set according to the corrected annotation data.

In one possible implementation, the training sub-module is configured to: obtain a global loss and a false positive penalty loss of the neural network according to the training sample data set in combination with a preset weight coefficient respectively; determine a loss function of the neural network according to the global loss and the false positive penalty loss; and train the neural network according to back propagation of the loss function.

In one possible implementation, the segmentation module is configured to: perform segmentation processing on the intermediate processing image by means of Grow Cut, to obtain the first segmentation result, where the Grow Cut is implemented in a graphic processing unit through a deep learning framework.

In one possible implementation, the structure reconstruction module includes: a center extraction sub-module, configured to perform center extraction on the first segmentation result to obtain a central region image and a distance field value set, where the distance field value set is a set of distance field values between all voxel points on the central region image and a boundary of the target object in the first segmentation result; a topological structure generation sub-module, configured to generate a first topological structure diagram of the target object according to the central region image; a connection processing sub-module, configured to perform connection processing on the first topological structure diagram to obtain a second topological structure diagram; and a structure reconstruction sub-module, configured to perform structure reconstruction on the second topological structure diagram according to the distance field value set, to obtain the final segmentation result of the target object in the to-be-processed image.

In one possible implementation, the connection processing sub-module is configured to: extract a connected region corresponding to the target object from the first topological structure diagram; and remove voxel points from the first topological structure diagram whose connectivity values with the connected region are lower than a connectivity threshold, to obtain a second topological structure diagram.

In one possible implementation, the structure reconstruction sub-module is configured to: perform drawing by taking each point in the second topological structure diagram as a sphere center and each distance field value in the distance field value set as a radius, and adding the overlapping region included in the drawing to the second topological structure diagram, to obtain the final segmentation result of the target object in the to-be-processed image.

In one possible implementation, the apparatus further includes a preprocessing module before the feature extraction module, where the preprocessing module is configured to: performing preprocessing on the to-be-processed image, where the preprocessing includes one or more of resampling, value definition, and normalization.

In some embodiments, functions or modules included in the apparatus provided in the embodiments of the present disclosure may be configured to perform the method described in the foregoing method embodiments. For specific implementation of the apparatus, reference may be made to descriptions of the foregoing method embodiments. For brevity, details are not described here again.

The embodiments of the present disclosure further provide a computer-readable storage medium, having computer program instructions stored thereon, where when the computer program instructions are executed by a processor, the foregoing method is implemented. The computer-readable storage medium may be a non-volatile computer-readable storage medium.

The embodiments of the present disclosure further provide an electronic device, including: a processor; and a memory configured to store processor-executable instructions, where the processor is configured to execute the foregoing method.

The electronic device may be provided as a terminal, a server, or other forms of devices.

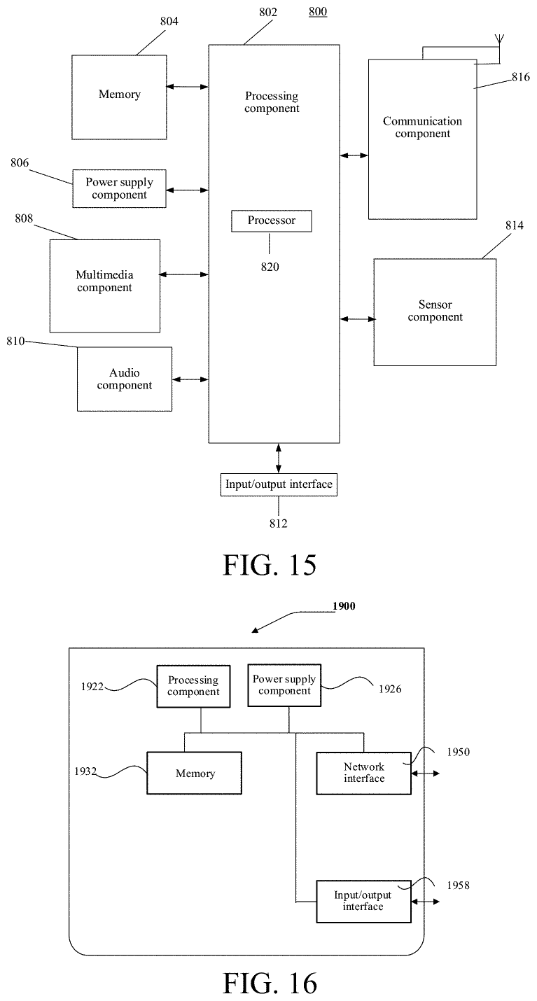

FIG. 15 is a block diagram of an electronic device 800 according to an exemplary embodiment. For example, the electronic device 800 may be a terminal such as a mobile phone, a computer, a digital broadcast terminal, a message transceiver device, a game console, a tablet device, a medical device, exercise equipment, and a personal digital assistant.

Referring to FIG. 15, the electronic device 800 may include one or more of the following components: a processing component 802, a memory 804, a power supply component 806, a multimedia component 808, an audio component 810, an Input/Output (I/O) interface 812, a sensor component 814, and a communication component 816.

The processing component 802 generally controls overall operation of the electronic device 800, such as operations associated with display, phone calls, data communications, camera operations, and recording operations. The processing component 802 may include one or more processors 820 to execute instructions to implement all or some of the steps of the method above. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations on the electronic device 800. Examples of the data include instructions for any application or method operated on the electronic device 800, contact data, contact list data, messages, pictures, videos, and etc. The memory 804 may be implemented by any type of volatile or non-volatile storage device, or a combination thereof, such as a Static Random-Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or an optical disk.

The power supply component 806 provides power for various components of the electronic device 800. The power supply component 806 may include a power management system, one or more power supplies, and other components associated with power generation, management, and distribution for the electronic device 800.

The multimedia component 808 includes a screen between the electronic device 800 and a user that provides an output interface. In some embodiments, the screen may include a Liquid Crystal Display (LCD) and a Touch Panel (TP). If the screen includes a TP, the screen may be implemented as a touch screen to receive input signals from the user. The TP includes one or more touch sensors for sensing touches, swipes, and gestures on the TP. The touch sensor may not only sense the boundary of a touch or swipe action, but also detect the duration and pressure related to the touch or swipe operation. In some embodiments, the multimedia component 808 includes a front-facing camera and/or a rear-facing camera. When the electronic device 800 is in an operation mode, for example, a photography mode or a video mode, the front-facing camera and/or the rear-facing camera may receive external multimedia data. Each of the front-facing camera and the rear-facing camera may be a fixed optical lens system, or have focal length and optical zoom capabilities.

The audio component 810 is configured to output and/or input an audio signal. For example, the audio component 810 includes a microphone (MIC), and the microphone is configured to receive an external audio signal when the electronic device 800 is in an operation mode, such as a calling mode, a recording mode, and a voice recognition mode. The received audio signal may be further stored in the memory 804 or transmitted by means of the communication component 816. In some embodiments, the audio component 810 further includes a speaker for outputting the audio signal.

The I/O interface 812 provides an interface between the processing component 802 and a peripheral interface module, which may be a keyboard, a click wheel, a button, etc. The button may include, but is not limited to, a home button, a volume button, a start button, and a lock button.

The sensor component 814 includes one or more sensors for providing state assessment in various aspects for the electronic device 800. For example, the sensor component 814 may detect an on/off state of the electronic device 800, and relative positioning of components, which are the display and keypad of the electronic device 800, for example, and the sensor component 814 may further detect a position change of the electronic device 800 or a component of the electronic device 800, the presence or absence of contact of the user with the electronic device 800, the orientation or acceleration/deceleration of the electronic device 800, and a temperature change of the electronic device 800. The sensor component 814 may include a proximity sensor, which is configured to detect the presence of a nearby object when there is no physical contact. The sensor component 814 may further include a light sensor, such as a CMOS or CCD image sensor, for use in an imaging application. In some embodiments, the sensor component 814 may further include an acceleration sensor, a gyroscope sensor, a magnetic sensor, a pressure sensor, or a temperature sensor.

The communication component 816 is configured to facilitate wired or wireless communications between the electronic device 800 and other devices. The electronic device 800 may access a wireless network based on a communication standard, such as WiFi, 2G, or 3G, or a combination thereof. In an exemplary embodiment, the communication component 816 receives a broadcast signal or broadcast-related information from an external broadcast management system by means of a broadcast channel. In an exemplary embodiment, the communication component 816 further includes a Near Field Communication (NFC) module to facilitate short-range communication. For example, the NFC module may be implemented based on Radio Frequency Identification (RFID) technology, Infrared Data Association (IrDA) technology, Ultra-Wideband (UWB) technology, Bluetooth (BT) technology, and other technologies.

In an exemplary embodiment, the electronic device 800 may be implemented by one or more Application-Specific Integrated Circuits (ASICs), Digital Signal Processors (DSPs), Digital Signal Processing Devices (DSPDs), Programmable Logic Devices (PLDs), Field-Programmable Gate Arrays (FPGAs), controllers, microcontrollers, microprocessors, or other electronic elements, to execute the method above.

In an exemplary embodiment, a non-volatile computer-readable storage medium is further provided, for example, a memory 804 including computer program instructions, which can executed by the processor 820 of the electronic device 800 to implement the methods above.

FIG. 16 is a block diagram of an electronic device 1900 according to an exemplary embodiment. For example, the electronic device 1900 may be provided as a server. Referring to FIG. 16, the electronic device 1900 includes a processing component 1922 which further includes one or more processors, and a memory resource represented by a memory 1932 and configured to store instructions executable by the processing component 1922, for example, an application program. The application program stored in the memory 1932 may include one or more modules, each of which corresponds to a set of instructions. Further, the processing component 1922 may be configured to execute instructions so as to execute the above method.

The electronic device 1900 may further include a power supply component 1926 configured to execute power management of the electronic device 1900, a wired or wireless network interface 1950 configured to connect the electronic device 1900 to the network, and an I/O interface 1958. The electronic device 1900 may be operated based on an operating system stored in the memory 1932, such as Windows Server™, Mac OS X™, Unix™, Linux™, FreeBSD™ or the like.

In an exemplary embodiment, a non-volatile computer-readable storage medium is further provided, for example, a memory 1932 including computer program instructions, which can executed by the processing component 1922 of the electronic device 1900 to implement the method above.

The present disclosure may be a system, a method, and/or a computer program product. The computer program product may include a computer-readable storage medium, on which computer-readable program instructions used by the processor to implement various aspects of the present disclosure are stored.

The computer-readable storage medium may be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. More specific examples (a non-exhaustive list) of the computer-readable storage medium include: a portable computer diskette, a hard disk, a Random Access Memory (RAM), an ROM, an EPROM (or a flash memory), a SRAM, a portable Compact Disk Read-Only Memory (CD-ROM), a Digital Versatile Disc (DVD), a memory stick, a floppy disk, a mechanically encoded device such as punch-cards or raised structure in a groove having instructions stored thereon, and any suitable combination thereof. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a Local Area Network (LAN), a wide area network and/or a wireless network. The network may include copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer program instructions for carrying out operations of the present disclosure may be assembler instructions, Instruction-Set-Architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In a scenario involving a remote computer, the remote computer may be connected to the user's computer through any type of network, including a LAN or a Wide Area Network (WAN), or the connection may be made to an external computer (for example, through the Internet using an Internet service provider),In some embodiments, an electronic circuit such as a programmable logic circuit, an FPGA, or a Programmable Logic Array (PLA) is personalized by using status information of the computer readable program instructions, and the electronic circuit may execute the computer readable program instructions to implement various aspects of the present disclosure.

Various aspects of the present disclosure are described here with reference to the flowcharts and/or block diagrams of the methods, apparatuses (systems), and computer program products according to the embodiments of the present disclosure. It should be understood that each block of the flowcharts and/or block diagrams, and combinations of the blocks in the flowcharts and/or block diagrams can be implemented by computer-readable program instructions.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can cause a computer, a programmable data processing apparatus, and/or other devices to function in a particular manner, such that the computer-readable medium having instructions stored therein includes an article of manufacture instructing instructions which implement the aspects of the functions/acts specified in one or more blocks of the flowcharts and/or block diagrams.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus or other device implement the functions/acts specified in one or more blocks of the flowcharts and/or block diagrams.

The flowcharts and block diagrams in the accompanying drawings show architectures, functions, and operations that may be implemented by the systems, methods, and computer program products in the embodiments of the present disclosure. In this regard, each block in the flowchart of block diagrams may represent a module, segment, or portion of instruction, which includes one or more executable instructions for implementing the specified logical function(s),In some alternative implementations, the functions noted in the block may also occur out of the order noted in the accompanying drawings. For example, two blocks shown in succession may, in fact, be executed substantially concurrently, or the blocks may sometimes be executed in the reverse order, depending upon the functionality involved. It should also be noted that each block of the block diagrams and/or flowcharts, and combinations of blocks in the block diagrams and/or flowcharts, can be implemented by special purpose hardware-based systems that perform the specified functions or acts or carried out by combinations of special purpose hardware and computer instructions.

The embodiments of the present disclosure are described above. The foregoing descriptions are exemplary but not exhaustive, and are not limited to the embodiments of the disclosure. Many modifications and variations will be apparent to persons of ordinary skill in the art without departing from the scope and spirit of the described embodiments. The terminology used herein was chosen to best explain the principles of the embodiments, the practical application or technical improvement over technologies found in the marketplace, or to enable other persons of ordinary skill in the art to understand the embodiments disclosed herein.

What is claimed is:

1. An image processing method, comprising:
performing feature extraction on a to-be-processed image to obtain an intermediate processing image;
performing segmentation processing on the intermediate processing image to obtain a first segmentation result; and
performing structure reconstruction on the first segmentation result according to structure information of the first segmentation result, to obtain a final segmentation result of a target object in the to-be-processed image.

2. The method according to claim 1, wherein performing feature extraction on the to-be-processed image to obtain the intermediate processing image comprises:
cutting the to-be-processed image according to a predetermined direction to obtain multiple to-be-processed sub-images;
performing feature extraction on each of the to-be-processed sub-images to obtain an intermediate processing sub-image respectively corresponding to each to-be-processed sub-image; and
splicing the intermediate processing sub-images according to the predetermined direction to obtain the intermediate processing image.

3. The method according to claim 2,
wherein cutting the to-be-processed image according to the predetermined direction to obtain the multiple to-be-processed sub-images comprises:
determining multiple cutting centers on the to-be-processed image; and
cutting the to-be-processed image according to the predetermined direction in accordance with positions of the cutting centers to obtain the multiple to-be-processed sub-images, wherein each cutting center is located at the center of a corresponding to-be-processed sub-image respectively, and an overlapping region exists between adjacent to-be-processed sub-images.

4. The method according to claim 2, wherein before cutting the to-be-processed image according to the predetermined direction to obtain the multiple to-be-processed sub-images, the method further comprises:
performing scaling processing on the to-be-processed image in directions other than the predetermined direction according to predetermined parameters.

5. The method according to claim 1, wherein before performing feature extraction on the to-be-processed image to obtain the intermediate processing image, the method further comprises:
obtaining a training sample data set; and
training, according to the training sample data set, a neural network used for feature extraction.

6. The method according to claim 5, wherein obtaining the training sample data set comprises:
correcting original data to obtain corrected annotation data; and
obtaining the training sample data set according to the corrected annotation data.

7. The method according to claim 5, wherein training, according to the training sample data set, the neural network used for feature extraction comprises:
obtaining a global loss and a false positive penalty loss of the neural network according to the training sample data set in combination with a preset weight coefficient respectively;
determining a loss function of the neural network according to the global loss and the false positive penalty loss; and
training the neural network according to back propagation of the loss function.

8. The method according to claim 1, wherein performing segmentation processing on the intermediate processing image to obtain the first segmentation result comprises:
performing segmentation processing on the intermediate processing image by means of Grow Cut, to obtain the first segmentation result, wherein the Grow Cut is implemented in a graphic processing unit through a deep learning framework.

9. The method according to claim 1, wherein performing structure reconstruction on the first segmentation result according to the structure information of the first segmentation result, to obtain the final segmentation result of the target object in the to-be-processed image comprises:
performing center extraction on the first segmentation result to obtain a central region image and a distance field value set, wherein the distance field value set is a set of distance field values between all voxel points on the central region image and a boundary of the target object in the first segmentation result;
generating a first topological structure diagram of the target object according to the central region image;
performing connection processing on the first topological structure diagram to obtain a second topological structure diagram; and
performing structure reconstruction on the second topological structure diagram according to the distance field value set, to obtain the final segmentation result of the target object in the to-be-processed image.

10. The method according to claim 9, wherein performing connection processing on the first topological structure diagram to obtain the second topological structure diagram comprises:
extracting a connected region corresponding to the target object from the first topological structure diagram; and
removing voxel points from the first topological structure diagram whose connectivity values with the connected region are lower than a connectivity threshold, to obtain a second topological structure diagram.

11. The method according to claim 9, wherein performing structure reconstruction on the second topological structure diagram according to the distance field value set, to obtain the final segmentation result of the target object in the to-be-processed image comprises:
performing drawing by taking each point in the second topological structure diagram as a sphere center and each distance field value in the distance field value set as a radius, and adding the overlapping region comprised in the drawing to the second topological structure diagram, to obtain the final segmentation result of the target object in the to-be-processed image.

12. The method according to claim 1, wherein before performing feature extraction on the to-be-processed image to obtain the intermediate processing image, the method further comprises:
performing preprocessing on the to-be-processed image, wherein the preprocessing comprises one or more of resampling, value definition, and normalization.

13. An image processing apparatus, comprising:
a processor; and
a memory configured to store processor-executable instructions,
wherein the processor is configured to invoke the instructions stored in the memory, so as to:
perform feature extraction on a to-be-processed image to obtain an intermediate processing image;
perform segmentation processing on the intermediate processing image to obtain a first segmentation result; and
perform structure reconstruction on the first segmentation result according to structure information of the first segmentation result, to obtain a final segmentation result of a target object in the to-be-processed image.

14. The apparatus according to claim 13, wherein performing the feature extraction on the to-be-processed image to obtain the intermediate processing image comprises:
cutting the to-be-processed image according to a predetermined direction to obtain multiple to-be-processed sub-images;
performing feature extraction on each of the to-be-processed sub-images to obtain an intermediate processing sub-image respectively corresponding to each to-be-processed sub-image; and
splicing the intermediate processing sub-images according to the predetermined direction to obtain the intermediate processing image.

15. The apparatus according to claim 14, wherein cutting the to-be-processed image according to the predetermined direction to obtain the multiple to-be-processed sub-images comprises:
determining multiple cutting centers on the to-be-processed image; and
cutting the to-be-processed image according to the predetermined direction in accordance with positions of the cutting centers to obtain the multiple to-be-processed sub-images, wherein each cutting center is located at the center of a corresponding to-be-processed sub-image respectively, and an overlapping region exists between adjacent to-be-processed sub-images.

16. The apparatus according to claim 14, wherein before cutting the to-be-processed image according to the predetermined direction to obtain the multiple to-be-processed sub-images, the processor is further configured to invoke the instructions stored in the memory, so as to:
perform scaling processing on the to-be-processed image in directions other than the predetermined direction according to predetermined parameters.

17. The apparatus according to claim 13, wherein before performing the feature extraction on the to-be-processed image to obtain the intermediate processing image, the processor is further configured to invoke the instructions stored in the memory, so as to:
obtain a training sample data set; and
train, according to the training sample data set, a neural network used for feature extraction.

18. The apparatus according to claim 17, wherein obtaining the training sample data set comprises:
correcting original data to obtain corrected annotation data; and
obtaining the training sample data set according to the corrected annotation data.

19. The apparatus according to claim 17, wherein training, according to the training sample data set, the neural network used for feature extraction comprises:
obtaining a global loss and a false positive penalty loss of the neural network according to the training sample data set in combination with a preset weight coefficient respectively;
determining a loss function of the neural network according to the global loss and the false positive penalty loss; and
training the neural network according to back propagation of the loss function.

20. A non-transitory computer-readable storage medium, having computer program instructions stored thereon, wherein when the computer program instructions are executed by a processor, the processor is caused to perform the operations of:
performing feature extraction on a to-be-processed image to obtain an intermediate processing image;
performing segmentation processing on the intermediate processing image to obtain a first segmentation result; and
performing structure reconstruction on the first segmentation result according to structure information of the first segmentation result, to obtain a final segmentation result of a target object in the to-be-processed image.
